(19) United States
(12) Patent Application Publication
(10) Pub. No.: US 2008/0222857 A1
(43) Pub. Date: Sep. 18, 2008

(54) Apparatus and Methods for Clamping A Window

(75) Inventors: Michael Twork, White Lake, MI (US); Stephen P. Jones, Commerce, MI (US); Lawrence Demeniuk, Sterling Heights, MI (US)

Correspondence Address: KAPLAN GILMAN GIBSON & DERNIER L.L.P., 900 ROUTE 9 NORTH, WOODBRIDGE, NJ, 07095, US

(73) Assignee: FAURECIA INTERIOR SYSTEMS U.S.A., INC., Auburn Hills, MI (US)

(21) Appl. No.: 11/684,937

(22) Filed: Mar. 12, 2007

(51) Int. Cl. A44B 21/00; A44B 17/00; E06B 3/02

(52) U.S. Cl. 24/541; 24/542; 49/506

(57) ABSTRACT

A lift plate for holding a window pane is disclosed which may include a clamp operable to grasp a window pane with a grasping force responsive to a force of insertion of the window pane into the clamp; and a reinforcement system operable to follow a movement of at least a portion of the clamp and to prevent retraction of the clamp from a grasping position with respect to the window pane.

### BACKGROUND OF THE INVENTION

Various approaches have been implemented for installing glass panes into window regulators. One existing approach involves bolting steel clamps together about the bottom edge of a glass pane. Another approach involves bonding a bracket onto a pane of glass and riveting or bonding the bracket to a regulator lift plate. The above approaches suffer from the disadvantage of requiring that a fastening operation be performed after installing the glass pane into the window regulator, thereby adding time and cost to the installation procedure.

Another existing approach avoids the need for a post-installation fastening operation by providing a plastic lift plate having a hook that extends into a hole in the glass pane during installation. While the plastic lift plate approach may represent an improvement in the art, providing a hole in the glass also adds time and expense to the overall manufacturing process.

Accordingly, there is a need in the art for improved methods and apparatus for installing a window pane into a window regulator.

### SUMMARY OF THE INVENTION

According to one aspect, the invention is directed to a lift plate for holding a window pane that may include a clamp operable to grasp a window pane with a grasping force responsive to a force of insertion of the window pane into the clamp; and a reinforcement system operable to follow a movement of at least a portion of the clamp and to prevent retraction of the clamp from a grasping position with respect to the window pane.

According to another aspect, the invention may include a method for securing a window pane to a lift plate, that may include inserting a window pane into a clamp with an insertion force; causing the clamp to grasp the window pane with a given grasping force responsive to the insertion force; and advancing a reinforcement system to a first position to maintain the given grasping force of the clamp on the window pane.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a schematic diagram of a lift plate in an unclamped condition in accordance with one or more embodiments of the present invention;

FIG. 2 is a schematic diagram of the lift plate of FIG. 1 in a clamped condition in accordance with one or more embodiments of the present invention;

FIG. 3 is a schematic diagram of the lift plate of FIG. 1 after release of the clamp in accordance with one or more embodiments of the present invention;

FIG. 4 is a schematic diagram of a lift plate in an unclamped condition in accordance with one or more further embodiments of the present invention; and

FIG. 5 is a schematic diagram of the lift plate of FIG. 4 in a clamped condition in accordance with one or more embodiments of the present invention.

### DETAILED DESCRIPTION OF THE PREFERRED EMBODIMENTS

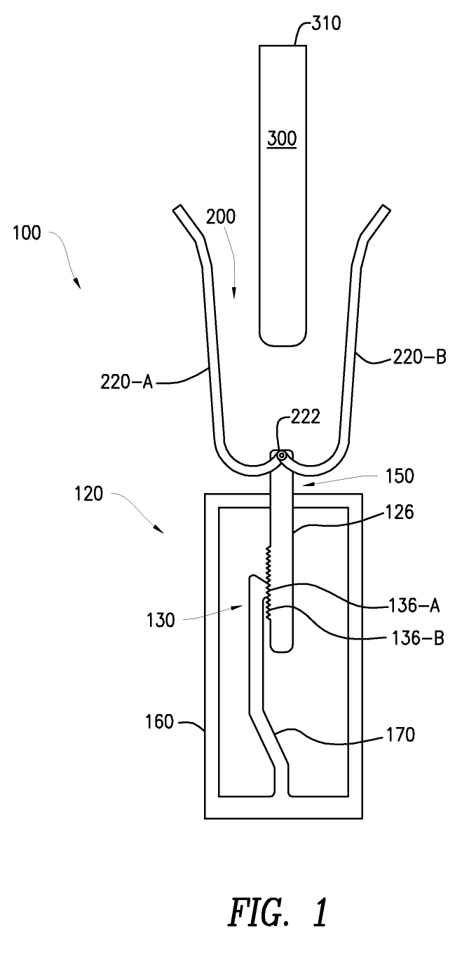

FIG. 1 is a schematic diagram of a lift plate 100 in an unclamped condition in accordance with one or more embodiments of the present invention. The lift plate 100 may include clamp 200, window pane 300, reinforcement system 120, and reinforcement system housing 160. The clamp 200 is operable to grasp the window pane 300 with a grasping force responsive to a force of insertion of the window pane 300 into the clamp 200. The reinforcement system 120 is operable to follow movement of the clamp 200 and to prevent retraction of the clamp 200 from a grasping position with respect to the window pane 300.

In one or more embodiments, clamp 200 may be made of any suitable material including steel or other metal, plastic, other suitable material, or any combination of one or more of the foregoing. Clamp 200 may include a first portion that includes steel as one principal structural component, and/or may include a second portion that interfaces with window pane 300 which may include a material with a lower durometer than glass, whether metallic or non-metallic, which may be operable to avoid damaging the surface of window pane 300. The low-durometer material may be disposed along an internal surface of clamp 200 to interface with window pane 300. Pane 300 may be of glass, plastic, other suitable material, or any combination of the foregoing. The various parts in reinforcement system 120 may be made of any suitable material, including plastic, any suitable metal, ceramic, or any combination of one or more of the foregoing.

The following is directed the operability of window lift plate 100 to maintain a grasping force, or clamping force, of clamp 200 on pane 300 by preventing clamp 200 from retracting from a grasping position about pane 300. As shown in FIG. 1, clamp 200 may include clamp sides 220-a and 220-b, and inner peak 222. Reinforcement system 120 may include tracking system 150 and/or locking mechanism 130. Tracking system 150 may include clamp follower 126. Locking mechanism 130 may include opposed sets of teeth 136-a and 136-b, and/or release mechanism 170, which may be a lever. Housing 160 may be coupled to the body of lift plate 100 which may in turn be coupled to window regulator cables or other lift mechanism to move lift plate 100, along with the assembly shown in FIG. 1, along a window guide path. Opposed sets of teeth 136-a and 136-b may be configured so as to enable only one-way movement, that is, downward movement of follower 126, with respect to lever 170. Reinforcement system 120 may be securely attached to lift plate 100.

Locking mechanism 130 may be operable to cooperate with follower 126 and lever 170 to prevent follower 126 from retracting upward along the vertical axis shown in FIG. 1. In this manner, locking mechanism 130 may be operable to prevent retraction of clamp inner peak 222 and/or clamp 200 as a whole from a grasping position with respect to pane 300. Preventing clamp 200 retraction, as described above, may operate to maintain a clamping force of clamp 200 on window pane 300.

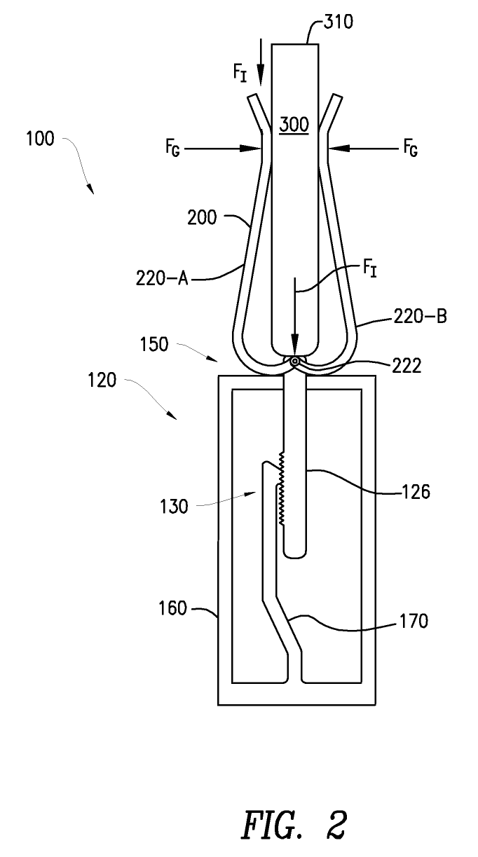

The clamp follower 126 is coupled to inner peak 222 of “W” shaped clamp 200. In this embodiment, force directed downward on inner peak 222 may operate to force follower 126 downward into housing 160. As shown in FIG. 2, which is a schematic diagram of the lift plate 100 of FIG. 1 in a clamped condition, pane 300 is fully inserted into clamp 200. The insertion shown in FIG. 2 may correspond to a result of an initial insertion of pane 300 into clamp 200.

An insertion force F_{I} may be applied to insert pane 300 into clamp 200. The “W” shape of clamp 200 (FIG. 1) in its unclamped condition may enable clamp 200 to impart a grasping force F_{G} to pane 300 in response to the application of insertion force F_{I} to inner peak 222 of pane 300. As discussed previously, other configurations of clamp 200 and devices other than clamp 200 may be employed to convert the insertion force F_{I} into a grasping force F_{G} for grasping pane 300, and all such variations are intended to be included within the scope of the present invention.

In one or more embodiments, in addition to the grasping force F_{G} being activated or initiated by the application of the insertion force F_{I} of pane 300 into clamp 200, the magnitude of the force F_{G} may be a function of the magnitude of the force F_{I}. For example, in one or more embodiments, the magnitude of F_{G} may be similar to or the same as the magnitude of F_{I}. In other embodiments, the magnitude of F_{G} may be linearly proportional to the magnitude of F_{I}. In one or more other embodiments, the magnitude of F_{G} may be any linear or non-linear function of F_{I}, or any combination of the two.

As pane 300 advances into clamp 200, inner peak 222 of clamp 200 may be pushed downward by the lower edge of pane 300. The W-shape of clamp 200 may cause clamp sides 220-a and 220-b to close on in pane 300 with a grasping force F_{G} having a magnitude that may be a function the magnitude of the force F_{I} with which pane 300 is inserted into clamp 200. More specifically, deflection of inner peak 222 along the direction of force F_{I} may initially cause clamp walls 220-a and 220-b to pivot about the pivot point at inner peak 222 and thereby rotate toward one another to engage respective surfaces of window pane 300. After initial contact between clamps walls 220 and the pane 300 surfaces is made, further deflection of inner peak 222 (in the insertion direction) may cause clamp walls 220 to deflect, thereby applying clamp wall 220 spring forces to the surfaces of window pane 300. The clamp wall 220 spring forces may thus combine to provide grasping force F_{G}.

The movement of inner peak 222 of clamp 200 may cause a corresponding downward movement of clamp follower 126 into housing 160. The movement of follower 126 may cause teeth 136-b of follower 126 to move with respect to teeth 136-a of lever 170. The opposed sets of teeth 136-a, 136-b may combine to form a ratchet 130 that may be aligned with the direction of insertion of the window pane 300. Ratchet 130 may be operable to latch, or lock, the advancement (downward movement in the embodiment of FIGS. 1-2) of follower 126 into housing 160 to prevent follower 126 from retracting from a position reached in response to the application of insertion force F_{I} on inner peak 222 and follower 126. The ratchet 30 may be linear or rotary. This prevention of retraction of follower 126 may operate to prevent clamp 200 from retracting from a grasping position with respect to pane 300.

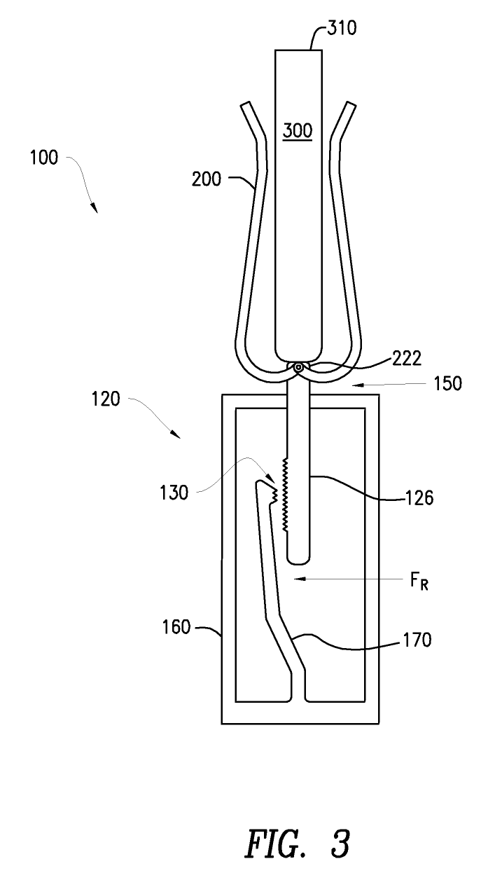

FIG. 3 is a schematic diagram of the lift plate 100 of FIG. 1 after release of the clamp 200 in accordance with one or more embodiments of the present invention. For various reasons, it may be desirable to enable releasing pane 300 from lift plate 100, to replace pane 300, to service one or more portions of lift plate 100, or for other purposes. Accordingly, a mechanism for releasing pane 300, such as release mechanism 170 may be provided. Various possible embodiments of release mechanism 170 may be implemented which will be apparent to those of ordinary skill in the art. In the embodiment of FIGS. 1-3, release mechanism 170 may be a lever which may pivot so as to rotate counter-clockwise (in the view of FIG. 3) to disengage sets of teeth 136-a and 136-b and thereby disable (or disconnect) the restriction on upward motion of follower 126. The pivot point for lever 170 could be anywhere. However, in the embodiment of FIG. 3, lever 170 may pivot about a point near the bottom of housing 160. Alternatively, a release mechanism 180 for releasing pane 300 may be employed which provides one or more of: manual intervention, intervention employing at least one tool, which tool may be customized for use with reinforcement system 120, applying a voltage to a circuit operable to release the ratchet 130, and/or applying pressure, such as air pressure, at a designated point. However, one skilled in the art will appreciate that other forms of intervention may be employed.

Although, as discussed above, force directed downward on inner peak 222 may operate to force follower 126 downward into housing 160, it will be appreciated by those of skill in the art that numerous variations of clamp 200 and reinforcement system 120 may be practiced while remaining within the scope of the present invention. Moreover, while a single clamp 200 has been shown and described as coupled to a single reinforcement system 120, any number of clamps 200 and/or reinforcement systems 120 may be deployed to aid in securing window pane 300 to lift plate 100. Further, in alternative embodiments, follower 126 could be urged toward inner peak 222 under spring force and need not be rigidly coupled thereto.

In one or more embodiments, grasping mechanisms other than the “W-shaped” clamp 200 may be employed to provide a grasping force, either horizontally or otherwise, on pane 300 in response to an insertion force, directed vertically, horizontally, or otherwise, on pane 300 causing pane 300 to enter clamp 200.

Moreover, reinforcement system 120 may be situated and constructed differently from the embodiment shown in FIG. 1 and provide a similar or the same function. For example, mechanisms for preventing retraction of follower 126 with respect to lever 170 other than opposed sets of teeth 136-a, 136-b may be implemented. Moreover, in other embodiments, a reinforcement system, whether ratchet-based or not, may be anchored on clamp 200 itself, without requiring a separate attachment to a rigid portion of lift plate 100.

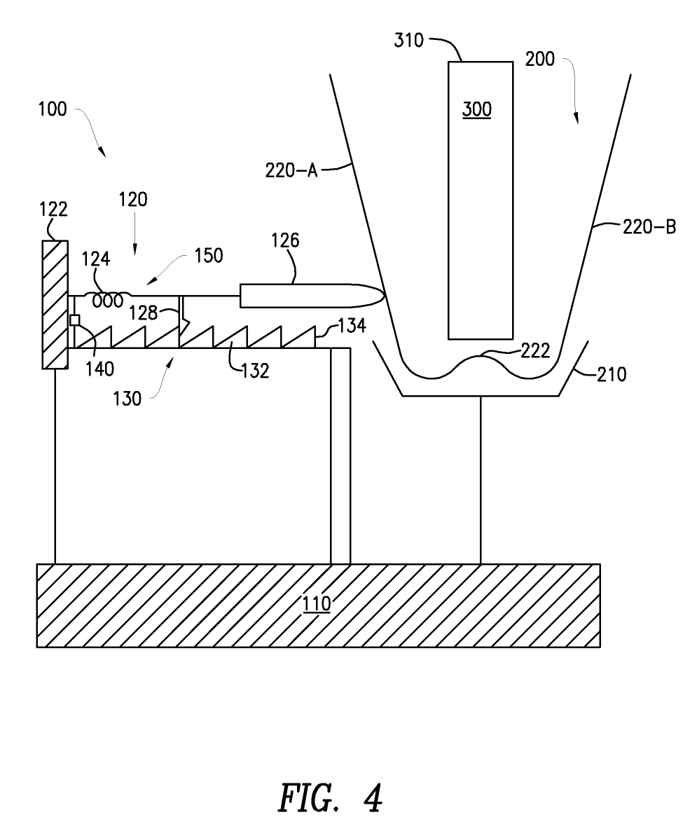

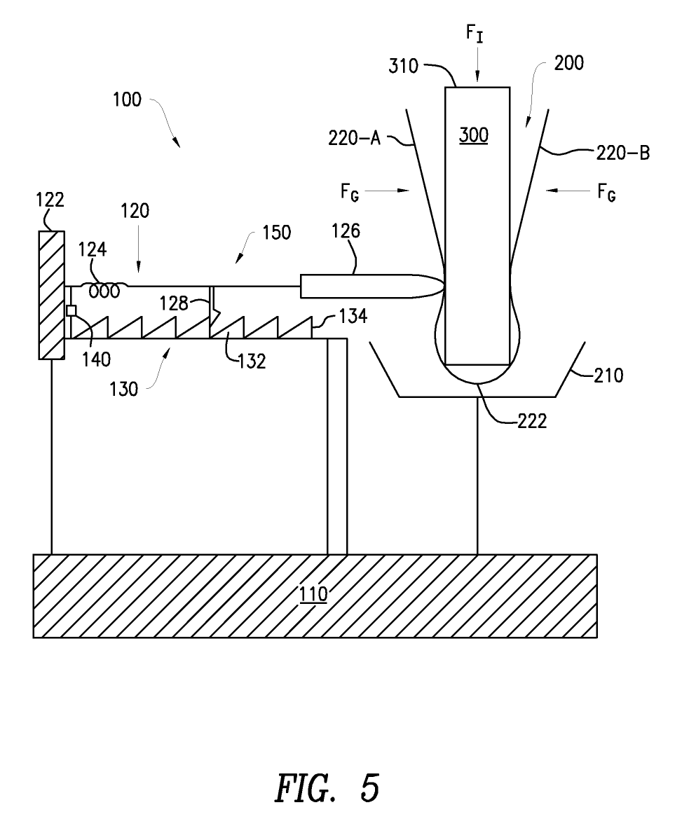

Further, the function of following a portion of clamp 200, whether inner peak 222, or other portion, may be enabled by various other mechanisms. Herein, in the embodiments of FIGS. 1-3, follower 126 may be connected coupled to inner peak 222 of W-shaped clamp 200 and may move in conjunction with inner peak 222 as the latter is forced downward by the insertion of pane 300 into clamp 200. In the embodiment of FIGS. 4-5, follower 126 need not be connected to clamp 200 side 220-a, yet may follow clamp side 220-a under the force of spring 124. In other embodiments, still other systems and methods for connecting follower 126 to other equipment within lift plate 100 and/or controlling the motion of follower 126 may be practiced.

Still further, mechanisms other than the locking mechanism 130, which may include opposed sets of teeth 136-a, 136-b shown in FIG. 1, could be employed for preventing retraction of clamp 200 from a grasping position thereof on pane 300. The following is directed to a discussion of the means employed by the embodiment of FIG. 1 to implement various operations in accordance with one or more embodiments of the present invention.

In one or more embodiments, clamp 200 may be operable to receive glass pane 300 therein and to grasp glass pane 300 with a grasping force that may be responsive to the force of the glass pane 300 insertion into clamp 200. Moreover, tracking system 150 and locking mechanism 130 may be operable to prevent retraction of clamp 200 from a grasping position with respect to pane 300. In the embodiment of FIG. 1, follower 126 may follow the movement of inner peak 222 of clamp 200 as pane 300 presses downward on inner peak 222. However, in other embodiments, other mechanisms for following, or tracking, the movement of inner peak 222, or other portion, of clamp 200 may be employed.

FIG. 4 is a schematic diagram of a lift plate 400 in an unclamped condition in accordance with one or more other embodiments of the present invention. The lift plate 100 may include base 110, clamp 200, window pane 300, and reinforcement system 120. Clamp 200 may include clamp bracket 210, clamp sides 220-a and 220-b, and inner peak 222. Reinforcement system 120 may include tracking system 150 and/or locking mechanism 130. Tracking system 150 may include backing plate 122, spring 124, and/or clamp follower 126. Locking mechanism 130 may be a ratchet 130, which may include catch 128, pawl 132 (which may include teeth 134), and/or release mechanism 140. The embodiment of FIGS. 4-5 may be operable to achieve a similar or the same result as that FIGS. 1-3 while employing a different arrangement of tracking system 150 and locking mechanism 130.

The following is directed the operability of the window lift plate 100 of FIG. 4 to maintain a grasping force, or clamping force, of clamp 200 on pane 300 by preventing clamp 200 from retracting from a grasping position about pane 300. This operation is discussed with reference to the embodiment of FIG. 4, which shows a linear spring 124 urging follower 126 rightward (in the view of FIG. 1) toward the left side 220-a of clamp 200.

However, in alternative embodiments, the function of following a portion of clamp 200, whether side 220-a other portion, may be enabled by various other mechanisms. In one or more alternative embodiments, the force of spring 124 could be provided by other sources such as compressed air, pneumatic pressure, and so forth. Moreover, portions of clamp 200 other than, or in addition to, side 220-a or 220-b could be followed. Further, in other embodiments, follower 126 could be rigidly attached to a portion of clamp 222 to thereby obviate a need for spring 124 to continually urge follower 124 toward clamp 200. The embodiment of FIGS. 1-2 shows one such embodiment.

Still further, mechanisms other than the linear ratchet 130 shown in FIG. 4 could be employed for preventing retraction of clamp 200 from a grasping position thereof on pane 300. The following is directed to a discussion of the means employed by the embodiment of FIG. 4 to implement various operations in accordance with one or more embodiments of the present invention.

In one or more embodiments, clamp 200 may be operable to receive glass pane 300 therein and to grasp glass pane 300 with a grasping force that may be responsive to the force of the glass pane 300 insertion into clamp 200. Moreover, reinforcement system 120 may be operable to follow the movement of side 220-A, or other portion of, clamp 200 to prevent retraction of clamp 200 from a grasping position with respect to pane 300. In the embodiment of FIG. 4, follower 126, with force from spring 124 that urges follower 126 toward clamp side 220-a, may be operable to follow side 220-a of clamp 200. However, in other embodiments, other mechanisms for following, or tracking, the movement of clamp side 220-a may be employed.

Ratchet 130 may be operable to cooperate with follower 126 and spring 124 to at least partially restrict the motion of follower 126, to prevent follower 126 from retracting along the left-to-right axis shown in FIG. 1. In this manner, ratchet 130 may be operable to prevent retraction of clamp side 220-a and/or clamp 200 as a whole from a grasping position with respect to pane 300. Preventing clamp 200 retraction, as described above, may operate to maintain a clamping force of clamp 200 on window pane 300.

FIG. 5 is a schematic diagram of the lift plate 100 of FIG. 1 in a clamped condition in accordance with one or more embodiments of the present invention. The parts included in lift plate 100 of FIG. 5 are the same as those already discussed in connection with FIG. 4. Accordingly, that discussion is not repeated in this section. FIG. 5 shows pane 300 fully inserted into clamp 200. The insertion shown in FIG. 5 may correspond to a result of an initial insertion of pane 300 into clamp 200. The operability of the W-shaped clamp 200 to impart a grasping force F_{G} in response to an insertion force F_{I} was discussed in connection with FIG. 2. Moreover, the various possible mathematical relationships between the magnitudes of F_{I} and F_{G} were also discussed in connection with FIG. 2. The prior descriptions of the insertion and grasping forces are applicable to the embodiments described in connection with FIGS. 4 and 5, and those discussions are therefore not repeated in this section.

As clamp 200 applies a grasping force F_{G} to pane 300 in response to the insertion force F_{I}, spring 124 may urge follower 126 toward side 220-a of clamp 200. It may be seen that, in the example of FIGS. 4 and 5, follower 126 has maintained contact with side 220-a of clamp 200. Moreover, in this example, catch 128 may advance by one or more teeth 134 along pawl 132 of ratchet 130 in transitioning from the unclamped condition of FIG. 4 to the clamped condition of FIG. 5. The advance of only a single tooth 134 along pawl 132 by catch 128 is shown for illustrative purposes. In one or more embodiments, any needed level of granularity (where increasing granularity corresponds to reduced distances between adjacent teeth) may be provided. Moreover, any needed adjustment range along pawl 132 may be provided.

In one or more embodiments, spring 124 need only provide sufficient force to enable follower 126 to track the movement of clamp 200 side 200-a. Once clamp 200 and/or clamp side 220-a come to rest at a grasping position with respect to pane 300, ratchet 130 may provide any needed force for preventing, or at least resisting or inhibiting, retraction of clamp 200 and/or any portion thereof, such as side 200-a, from this grasping position. More specifically, catch 128 may be lodged securely against a surface of a tooth 134 within pawl 132 of ratchet 130. In one or more embodiments, the catch 128 may be forced leftward toward one of the teeth 134 by a tendency of clamp 200 to expand outward from its clamped position. The pertinent tooth 134 may be operable, along with the supporting structure thereof, to resist the leftward force from catch 128 and to thereby maintain follower 126 in position against side 220-a of clamp 200, and thereby maintain the clamping force of clamp 200 on pane 300.

The catch 128 may be moveable along a vertical (in the view of FIGS. 1 and 2) axis to enable catch 128 to ride up the slanted portions of teeth 134 when moving rightward as clamp 200 moves to grasp pane 300 more tightly. Catch 128 may then return to the vertical position shown in FIG. 2 after moving past the corner (between the slanted edge and the vertical edge) of each tooth 134. However, in one or more alternative embodiments, other mechanisms for limiting follower 126 to one-way motion in a rightward (in the view of FIGS. 1 and 2) direction may be practiced.

In one or more embodiments, reinforcement system 120 of lift plate 100 may include at least one release mechanism 140 which may be operable to disable (or disconnect) ratchet 130 of reinforcement system 120 and thereby remove a force resisting the retraction of clamp 200 from a grasping position with respect to pane 300. The above actions may in turn enable release of window pane 300 by clamp 200. In the embodiment of FIG. 2, releasing the ratchet 130 may correspond to disabling the pawl 132 from restraining the leftward motion of catch 128 and/or tracking system 150 in response to an expansive force from clamp 220 and/or a leftward (in the view of FIG. 2) force from clamp 200 side 220-a.

One or more forms of intervention with reinforcement system 120 may be operable to disable the force applied to clamp 200 thereby. Such intervention may include one or more of, but is not limited to: manual intervention, intervention employing at least one tool, which tool may be customized for use with reinforcement system 120, applying a voltage to a circuit operable to activate release mechanism 140, and/or applying pressure, such as air pressure, at a designated point. However, in one or more other embodiments, other forms of intervention may be employed.

In one or more embodiments, a mechanism (not shown) for tempering the rate of retraction of clamp 200 and/or the follower 126 upon activation of release mechanism 140 may be implemented. Such a tempering mechanism may operate to prevent any sudden jolting toward the left (in the view of FIG. 2) of follower 126 and/or clamp side 220-a, upon releasing ratchet 130. Such a tempering mechanism may include one or more of: one or more springs, one or more air cylinders, one or more pneumatic devices and/or one or more active devices.

The above descriptions of the embodiments of FIGS. 1-3 and FIGS. 4-5 are principally directed to the effects of an initial insertion of pane 300 into clamp 200. The following discussion addresses the operability of reinforcement system 120, of one or more of the above-discussed embodiments, to preserve and/or restore the clamping force of clamp 200 using insertion forces applied to pane 300 toward clamp 200 during ongoing use of lift plate 100 within a window system.

The pane 300 may undergo an initial insertion into clamp 200 during assembly of lift plate 100 and/or of an automobile including lift plate 100. At this stage, an initial insertion force, an initial resulting clamp 200 grasping force responsive to the insertion force, and/or an initial advancement of reinforcement system 120 may be effected. In the above embodiments, the advancement of reinforcement system 120 to a first position may correspond to advancing follower 126 to a first position within locking mechanism 130.

Thereafter, subsequent applications of insertion force F_{I} may operate to maintain the grasping force of clamp 200 on pane 300. Such subsequent applications of force may occur within a factory setting, a subsequent vehicle preparation operation, and/or on an ongoing basis during the operating life of a vehicle that includes lift plate 100. If the subsequently applied insertion forces exceed the original insertion force applied to pane 300, the resulting grasping force could exceed the original grasping force of clamp 200 on pane 300.

The force with which window pane 300 is raised, either manually, or using an electric motor, may operate to determine the grasping force applied to pane 300 by clamp 200. More specifically, during ongoing operation of a motor vehicle including lift plate 100, as lift plate 100 is raised, along with window pane 300, within a vehicle window assembly, an upper edge 310 of pane 300 may ultimately come to rest against the interior of a window frame housing pane 300. Upon coming to rest as described, the upward force on pane 300, which may be a “stall force,” may also operate as an insertion force of pane 300 toward clamp 200. Thus, the upward force, whether manual or motorized, may serve to restore a grasping force on pane 300 from clamp 200 if the grasping force has diminished over time for any reason. In one or more embodiments, reinforcement system 120 may enable further advancement of locking mechanism 130 to maintain and/or restore the grasping force of the clamp 200 on the window pane 300. It is noted that the above process may be repeated every time a vehicle operator “closes” a vehicle window that includes window pane 300, throughout the life of the vehicle.

If the grasping force has declined below a given level, the upward force on pane 300, which may the stall force of an electric window motor, may cause reinforcement system 120 to repeat the above discussed process of having follower 126 follow a selected portion of clamp 200 into a final grasping position of clamp 200 with respect to pane 300. Moreover, locking mechanism 130 may serve, as discussed above, to prevent clamp 200 from retracting from the grasping position obtained as a result of the application of a motor stall force, or other force, of clamp 200 upward against pane 300.

In this manner, lift plate 100 may operate to adjust, or otherwise stated, restore, the clamping force of clamp 200 on pane 300 throughout the operating life of the lift plate 100 and that of the vehicle housing lift plate 100. This automatic clamp force restoration process may serve to compensate for factors including but not limited to material fatigue and/or creep of clamp 200, changes in the dimensions of pane 300, movement between pertinent portions of the lift plate 100 assembly and/or other factors.

In accordance with this function, locking mechanism 130 may be provided with a level of adjustment granularity suited to preserving fine adjustments in the advancement of follower 126 in response to a change in position of a selected portion of clamp 200. Further, locking mechanism 130 may also be provided with sufficient adjustment range to enable lift plate 100 to compensate for reductions in clamp 200 grasping force over the duration of the life of lift plate 100 and the vehicle housing same. In this manner, reinforcement system 120 may be advanced to a sequence of successive positions in response a sequence of applications of insertion forces, arising from window stall forces, of window pane 300 toward clamp 200.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A lift plate for holding a window pane comprising:
a clamp operable to grasp a window pane with a grasping force responsive to a force of insertion of the window pane into the clamp; and
a reinforcement system operable to follow a movement of at least a portion of the clamp and to prevent retraction of the clamp from a grasping position with respect to the window pane.

2. The lift plate of claim 1 wherein the reinforcement system comprises:
a tracking system operable to follow a movement of at least a portion of the clamp; and
a locking mechanism operable to lock the position of the tracking system.

3. The lift plate of claim 2 wherein the locking mechanism is one of a linear or rotary ratchet.

4. The lift plate of claim 3 wherein the ratchet comprises:
a catch operable to advance within the ratchet; and
a pawl operable to prevent retraction of the catch along or around an axis of the advancement thereof and to thereby prevent the retraction of the clamp from the grasping position.

5. The lift plate of claim 2 wherein the tracking system comprises at least one spring operable to urge the catch toward the clamp portion.

6. The lift plate of claim 1 further comprising a release mechanism operable to disable the reinforcement system.

7. The lift plate of claim 6 wherein the release mechanism is operable to disable the reinforcement system via at least one of: manual intervention; a tool; an applied voltage; and an applied pressure.

8. The lift plate of claim 1 wherein the clamp comprises at least two walls joined at a pivot point, wherein the pivot point forms an inner peak of the clamp, and wherein application of the insertion force of the window pane to the inner peak is operable to move the inner peak and impart the grasping force to the window pane.

9. The lift plate of claim 8 wherein the two walls and the pivot point of the clamp form a “W” shape.

10. The lift plate of claim 8 wherein application of the insertion force to the inner peak is operable to deflect the clamp walls toward the window pane and apply clamp forces against the window pane.

11. The lift plate of claim 8 wherein the reinforcement system comprises:
a tracking system operable to track the movement of the inner peak; and
a locking mechanism operable to prevent reversal of the movement of the inner peak arising from the insertion force.

12. The lift plate of claim 11 wherein:
the tracking system comprises a follower coupled to the inner peak; and
the locking mechanism comprises a ratchet operable to prevent retraction of the follower from a position reached in response to the insertion force.

13. The lift plate of claim 12 wherein the ratchet is aligned with a direction of insertion of the window pane.

14. The lift plate of claim 1 wherein the clamp and reinforcement system are operable to advance the reinforcement system to a first position upon initially installing the pane within the lift plate.

15. The lift plate of claim 14 wherein the clamp and reinforcement system are operable to at least one of:
advance the reinforcement system to at least one additional position during subsequent operation of the lift plate within a window assembly; and
advance the reinforcement system in response to fatigue or creep in material of the clamp.

16. The lift plate of claim 1 wherein the material of the clamp comprises a low-durometer material disposed along an internal surface of the clamp to interface with the window pane.

17. The lift plate of claim 1 wherein the magnitude of the grasping force is proportional to the magnitude of the insertion force.

18. A method for securing a window pane to a lift plate, comprising:
inserting a window pane into a clamp with an insertion force;
causing the clamp to grasp the window pane with a given grasping force responsive to the insertion force; and
advancing a reinforcement system to a first position to maintain the given grasping force of the clamp on the window pane.

19. The method of claim 18 further comprising advancing the reinforcement system to at least one additional position during movement of the window pane within a vehicle window system to restore the given grasping force.

20. The method of claim 19 wherein the step of advancing the reinforcement system into at least one additional grasping position at least one of:
compensates for a reduction in the grasping force over time; and
compensates for a reduction in the grasping force due to material fatigue or creep in the clamp.

21. The method of claim 18 further comprising releasing the reinforcement system to enable release of the window pane by the clamp.
